(19) United States
(12) Patent Application Publication
(10) Pub. No.: US 2007/0083524 A1
(43) Pub. Date: Apr. 12, 2007

(54) Apparatus, system, and method for implementing an IMS SOAP gateway to enable an IMS application to operate as a web service client

(76) Inventors: Haley Hoi Lee Fung, Alviso, CA (US); Shyh-Mei F. Ho, Cupertino, CA (US); Srividhya Srinivasan, San Jose, CA (US)

Correspondence Address: KUNZLER & ASSOCIATES, 8 EAST BROADWAY, SUITE 600, SALT LAKE CITY, UT, 84111, US

(21) Appl. No.: 11/311,796

(22) Filed: Dec. 19, 2005

Related U.S. Application Data
(63) Continuation-in-part of application No. 11/246,754, filed on Oct. 7, 2005.

(51) Int. Cl. G06F 17/30

(52) U.S. Cl. 707/10

(57) ABSTRACT

An apparatus, system, and method are disclosed for implementing an Information Management System (IMS) simple object access protocol (SOAP) gateway. The gateway extracts an identifier from a web service request received from an IMS application and selects a correlation mapping based on the extracted identifier. The gateway builds a modified web service request, updated with parameters from the correlation mapping. The added parameters allow the gateway to direct the web service request to a specific web service provider. Upon receiving a response from the web service provider, the gateway uses the correlation mapping including an IMS application identifier to properly route the web service response to a selected IMS application.

### CROSS-REFERENCES TO RELATED APPLICATIONS

This application is a continuation-in-part of, and claims priority to, U.S. patent application Ser. No. 11/246,754 entitled “Apparatus, System, and Method for Implementing an IMS SOAP Gateway” and filed on Oct. 7, 2005 for Haley Fung, et al., which is incorporated herein by reference.

### BACKGROUND OF THE INVENTION

1. Field of the Invention

This invention relates to enabling the use of a web service and more particularly relates to providing a gateway configured to allow an Information Management System (IMS) software product to operate as a simple object access protocol (SOAP) client and access a SOAP web service.

2. Description of the Related Art

Traditional computer applications provide computing services through an application interface. As an example, a word processor application allows a user to develop a text document using a computer. The word processor runs on a single computer and presents an interface to the user, normally on the same computer on which the word processor is running. A user sees a graphical representation of a document and edits the document using an interface provided by the word processor.

With the advent of the Internet, users often access information through web pages. A web server computer serves a web page, written using hypertext markup language (HTML) to client computers. A user of a client computer uses a web browser to access a web page on a web server computer using hypertext transport protocol (HTTP). A web browser typically establishes an HTTP session over a TCP/IP connection from the web browser computer to the web server computer. The world wide web (WWW) comprises a combination of web server computers and web service client computers connected using internet protocol (IP) which comprises transmission control protocol (TCP) and user datagram protocol (UDP).

Companies today provide services on the world wide web to their customers and others. Such services include transactional banking services, retail sales transactions, and information access services. Although companies could provide these services through HTML pages to users of web browsers, companies are beginning to provide automated services over the web using web services.

A web service is a specialized transactional service provided by a web service provider to a web service client. The web service client communicates with the web service provider using simple object access protocol (SOAP). SOAP is an XML-based messaging protocol that utilizes HTTP as a transport. As an example, a client application may initiate a request for the latest temperature reading at the John Wayne Airport. The client contacts a web service provider which maintains temperature recordings for the John Wayne Airport. The client initiates the request by sending a web service request in a SOAP message and receives a web service response in a SOAP message. The client retrieves the temperature value from the response. In this manner, web service clients are able to access vast amounts of data from databases and other sources using web services.

However, today, many of the largest transactional systems housing some of the largest databases of information cannot access web services. Legacy database systems lack the necessary functionality to access native web services. Some of the world's largest banks and institutions use IMS to maintain their financial databases.

Unfortunately, currently available products do not enable IMS to access web services via SOAP. Although the owners and operators of IMS systems would like to access native web services using IMS systems as a web client, no efficient method for IMS systems to natively access exists today. In addition, if such an access method existed, the method must be secure. Owners of IMS systems must maintain strict security regulations imposed by government laws and business requirements.

From the foregoing discussion, it should be apparent that a need exists for an apparatus, system, and method to allow a legacy IMS system to operate as a web client to access SOAP enabled web services. Beneficially, such an apparatus, system, and method would provide a highly efficient and secure method for IMS systems to access web services using SOAP and XML.

### SUMMARY OF THE INVENTION

The present invention has been developed in response to the present state of the art, and in particular, in response to the problems and needs in the art that have not yet been fully solved by currently available technology. Accordingly, the present invention has been developed to provide an apparatus, system, and method to implement an IMS SOAP gateway to allow an IMS system to operate as a web client to access native web services that overcome many or all of the above-discussed shortcomings in the art.

The IMS SOAP gateway is provided with a logic unit containing a plurality of modules configured to functionally execute the necessary steps to implement the gateway. These modules in the described embodiments include an IMS software product or IMS module, an IMS Connect software product or IMS connect module, an IMS datastore, an IMS application, a correlation module, a gateway connector, and a web interface comprising a SOAP endpoint and a SOAP message processor.

The IMS software product provides a transaction engine connected to a hierarchical database management system. The IMS Connect module provides a front end to the IMS software product configured to send and receive XML encoded messages over a TCP/IP connection while communicating with the IMS software product using legacy messaging schemes. The IMS datastore is a storage module contained within the IMS software product, and the IMS application is a procedure or program that runs in response to the transactional requirements of the IMS software product. The IMS application sends a web service request to the IMS Connect module.

The gateway connector receives the web service request from the IMS Connect module. The correlation module in turn extracts a web services identifier (WSID) from the web service request and selects a correlation mapping based on the extracted WSID. The correlation module further modifies the web service request to include an identifier extracted from the correlation mapping. The identifier may be a universal resource indicator (URI) to a destination web service provider. A web interface module then forwards the modified web service request to the destination web service provider over a SOAP session. The web interface comprises a SOAP processor and a SOAP endpoint.

The correlation mapping relates the WSID to a set of correlation parameters. These parameters may include a Universal Resource Indicator (URI), an IMS datastore identifier, an IMS Connect identifier, an IMS application identifier, and an adapter name, as well as other parameters. The continued processing of the web service request is dependent on the parameters added to the web service request by the web interface.

Typically, the web service provider returns a web service response to the web interface which may be returned synchronously or asynchronously to the IMS SOAP Gateway. The web interface and the correlation module may insert an IMS application identifier into the web service response as well as other correlation parameters to assist the IMS Connect module and IMS software product to properly route the web service response to the original IMS application or to a second IMS application. Processing of the web service response by the IMS application or the second IMS application may be synchronous or asynchronous with respect to the processing of the initial web service request.

A signal bearing medium capable of carrying out a method of the present invention is also presented. The signal bearing medium contains computer readable instructions which allow a computing device or a computing system to implement the gateway described above.

A computer program product is also presented. The computer program product comprises computer usable program code for deploying a computer program product and computer usable code for executing the computer program product. The computer program product comprises modules including a gateway connector, a correlation module, and a web interface. The deployed gateway connector is configured to establish an IP connection to an IMS software product. The IMS software product comprises an IMS Connect software product and an IMS application. The IMS application operates as a web client, creating a web service request containing a web service identifier (WSID). The IMS application sends the web service request to the gateway connector via the IMS Connect software product.

The correlation module extracts the WSID from the web service request and selects a correlation mapping based on the extracted WSID. The correlation mapping maps the WSID to one or more correlation mappings including a web service provider. The web interface encapsulates the web service request in a SOAP message and transmits the web service request to the web service provider.

The deployed gateway may receive a web service response from the web service provider and return the web service response to an IMS application designated by one of the correlation parameters.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the Features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system in accordance with the present invention;

FIG. 2 is a schematic block diagram of two modules of a system in accordance with the present invention;

FIG. 3 is a schematic block diagram of two modules of a system in accordance with the present invention;

FIG. 4 is a schematic block diagram of one module of a system in accordance with the present invention;

FIG. 5 is a schematic flow chart diagram illustrating one embodiment of a method in accordance with the present invention;

FIG. 6 is a schematic block diagram illustrating one embodiment of a system in accordance with the present invention;

FIG. 7 is a schematic block diagram of two modules of a system in accordance with the present invention;

FIG. 8 is a schematic block diagram illustrating one embodiment of a system in accordance with the present invention; and

FIG. 9 is a schematic block diagram illustrating one embodiment of a system in accordance with the present invention.

### DETAILED DESCRIPTION OF THE INVENTION

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Reference to a signal bearing medium may take any form capable of generating a signal, causing a signal to be generated, or causing execution of a program of machine-readable instructions on a digital processing apparatus. A signal bearing medium may be embodied by a transmission line, a compact disk, digital-video disk, a magnetic tape, a Bernoulli drive, a magnetic disk, a punch card, flash memory, integrated circuits, or other digital processing apparatus memory device.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

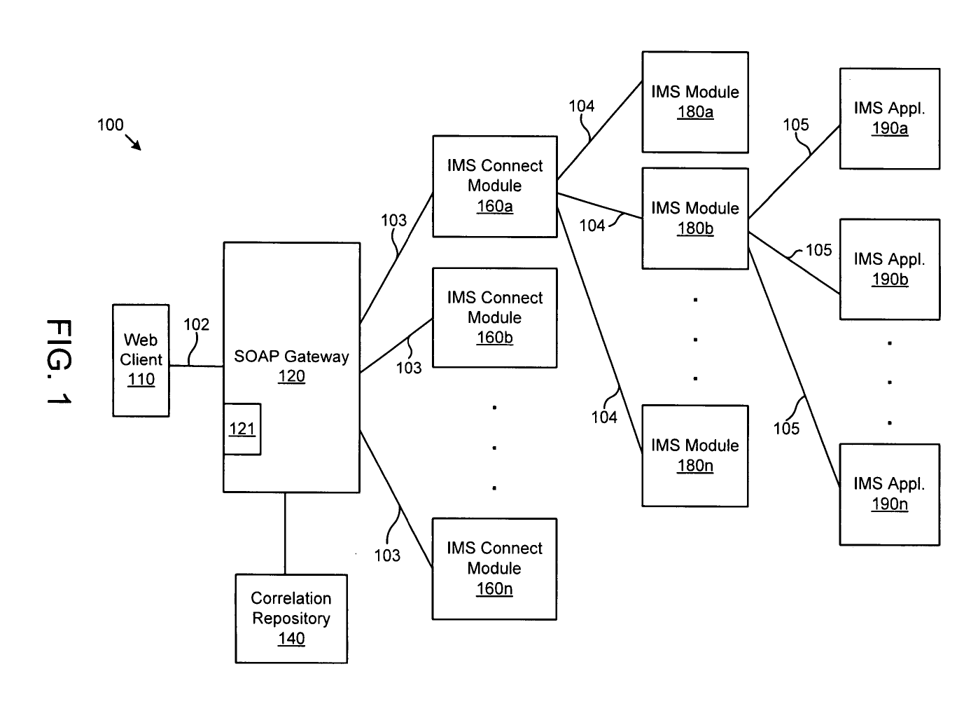

FIG. 1 illustrates a system 100 for implementing an Information Management System (IMS) simple object access protocol (SOAP) gateway. The system 100 includes a web service client 110, a SOAP gateway 120, an IMS Connect module software product 160, an IMS module software product 180, and an IMS application 190.

As illustrated, a single gateway 120 may connect to a plurality of IMS Connect modules 160a-n. Similarly, a single IMS Connect module 160a may connect to a plurality of IMS modules 180a-n, and a single IMS module 180b may connect to a plurality of IMS applications 190a-n. It is to be understood that the IMS Connect module 160, the IMS module 180 and the IMS application 190 may execute on a single computing device or each may execute on separate computing devices. Indeed, an International Business Machines (IBM) mainframe sysplex may present a single interface to non-sysplex machines while the sysplex itself may comprise a single computing device or multiple computing devices, typically mainframe computers running OS/390 or z/OS.

The design of the system 100 allows a web service client 110 to request a web service from gateway 120 without any knowledge of the complexity of the entire system 100. The system 100 routes a request from the web service client 110 to the gateway 120 and then to the appropriate IMS Connect module 160, the appropriate IMS module 180, and to the appropriate IMS application 190. The design of the system 100 further ensures that a response from the IMS application 190 will travel back through the appropriate IMS module 180, through the appropriate IMS Connect module 160, and to the gateway appropriate 120. Thus, the gateway 120 provides a simple external web service interface to the web service client 110. The gateway 120 shields the web service client 110 from the complexity of the system 100 and from the need to understand the flows and controls inherent in the system 100.

The web service client 110 typically is a software application running on a computing device connected to an intranet, extranet, internet or other IP based network. The web service client 110 is capable of creating XML-based requests and sending those requests to a web service provider. After creating an XML encoded request, the web service client encapsulates the request in a SOAP envelope and transmits the request to a web service provider over a SOAP conversation. Normally, web service provider responds by sending a SOAP based XML response over the same SOAP conversation. The web service client 110 may optionally retrieve a description of the parameters and interface supported by a potential web service provider and may use the parameters and interface description in constructing web service requests.

The gateway 120 acts as an interface between web service clients 110 and IMS Connect modules 160. The gateway 120 sends SOAP messages to, and receives SOAP messages from, web service clients 110 over SOAP conversation 102. The gateway 120 also sends XML messages to and receives XML messages from IMS Connect modules 160 over TCP/IP connection 103. In this manner, the gateway 120 presents a web service provider interface to the web service client 110 while hiding the complexity of system 100. The gateway 120 modifies requests received from the web service client 110 to include correlation parameters which allow the system 100 to route requests to the appropriate IMS Connect module 160, the appropriate IMS module 180, and the appropriate IMS application 190.

By providing a web service provider interface, the gateway 120 allows web service clients 110 to access legacy applications using modern software techniques. Similarly, by providing an XML interface to legacy systems, the gateway 120 allows legacy systems to interact with modern software products without having to rewrite the legacy systems to understand modern software interfaces. The gateway 120 retrieves correlation parameters from a correlation repository 140. The gateway 120 modifies web service requests to include appropriate correlation parameters.

The correlation repository 140 comprises sets of correlation mappings. Each correlation mapping comprises a set of correlation parameters. The correlation repository may be a file containing a plurality correlation mappings. The correlation repository may comprise a single file or a group of files. Those of skill in the art will realize that alternative forms may be used to store sets of correlation parameters in a correlation repository 140.

In one embodiment, the gateway 120 selects a mapping from the correlation repository 140 based on a universal resource indicator (URI) contained in a web service request received from a web service client 110. The URN serves as a web service provider identifier (WSPID), and the gateway 120 uses the WSPID as an index into the correlation repository 140 to select a correlation mapping. Thus, the correlation repository 140 contains a mapping that allows the gateway 120 to present a simple web service provider interface to the web service client and properly communicate with the complex system 100.

The IMS module 180 provides transactional services and database services. In one embodiment, the IMS module 180 includes the IMS Connect module 160 and the IMS application 190 within a single unit. However, the IMS module 180, the IMS Connect module 160 and the IMS application 190 may comprise separate functional 32 units.

The IMS Connect module 160 provides a TCP/IP interface between legacy IMS applications 190a-n and modem software clients. IMS Connect module 160 presents an XML interface for XML based communication while making legacy calls using traditional language protocols, such as COBOL formatted calls, for communications with IMS 180b. Using XML and XML schemas, software developers define parameter names and parameter formats which can be easily modified and extended.

In contrast, communication with legacy systems such as an IMS module 180 requires precise byte encodings. The IMS Connect module, in one embodiment, translates XML messages into byte encodings which the IMS 180 understands and then calls 104 the IMS module 180 using an Open Transaction Manager Access (OTMA) protocol. The IMS Connect module utilizes some of the correlation parameters mentioned above to properly translate the XML messages and to select the appropriate IMS module 180. The IMS Connect module 160 allows XML capable applications to access the IMS module 180 without requiring code modifications to be made to the IMS module 180. Advantageously, this permits continued use of legacy systems without large development expenses.

In one embodiment, the IMS module 180 may comprise a legacy transaction manager. Large banks and other institutions throughout the world extensively use the IMS module 180 to process millions of transactions each day. As mentioned above, the IMS module 180 communicates with the IMS Connect module 160 using the OTMA protocol. Working in cooperation with an IMS application 190, the IMS module 180 provides the bulk of the web service data processing of the system 100. Timeframes for making modifications to the IMS 180 are typically measured in years owing to the complexity of the system and the testing required before a new release becomes available. The long lead times for changes to the IMS module 180 make it advantageous to implement the IMS gateway 120 to allow modem web service clients to access the benefits of the IMS module 180 using SOAP and XML technologies.

The IMS application 190 is a software module connected to the IMS module 180. Typically, an IMS application 190 processes an individual transaction under the direction of the IMS module 180. The IMS module 180 may call an IMS application 190 using a queuing call 105. For example, an IMS application 190 may retrieve the balance from a specific bank account in response to an account query transaction and return the balance to the IMS module 180 over a call 105.

The gateway 120 may advertise the available web services that the gateway 120 offers an industry standard file known as a web services description language (WSDL) file. The gateway 120 advertises available services through the WSDL file 121. The WSDL file 121 may also advertise parameters which should be included on a web service request for a given web service.

The web service client 110 initiates a web service request by building an extended markup language (XML) message in compliance with the WSDL file 121 that corresponds with the desired web service. The client 110 encodes the various parameters in the web service request according to the WSDL file 121 specification.

In one embodiment, the WSDL file 121 advertises a web service under a specific web service name. The web service name may be a universal resource indicator (URI) or other identifier. The web service client 110 encodes the web service name into the web service request along with other parameters specified in the WSDL file 121 as an XML message. The web service client 110 encapsulates the web service request in a SOAP envelope, establishes a SOAP conversation with the gateway 120 and sends the web service request over the SOAP conversation 102 to the gateway 120.

The gateway 120 is configured to receive the web service request and extract an identifier from the web service request. The identifier may be the web service name or some other identifier specified in the web service request and required by the WSDL file 121. The identifier may comprise a web service provider identifier (WSPID). The gateway 120 accesses a correlation mapping within the correlation repository 140 using the extracted identifier as an index.

The gateway 120 uses the extracted correlation mapping to update the web service request. The updated web service request may include parameters which identify the proper IMS Connect module instance 160a, the proper IMS module instance 180b, the proper IMS application 190b, and optionally a specific database to be used in processing the web service request.

The system 100 provides various modules, methodologies, and parameters for accessing a web service comprising a gateway 120, a plurality of IMS Connect modules 160, a plurality of IMS modules 180, and a plurality of IMS applications 190. The web service client 110 uses a SOAP message to communicate the initial web service request to the gateway 120. The design of the system 100 allows an IMS module 180b executing one or more and the IMS applications 190a-n to provide web services to SOAP clients 110 without modifying the software of the IMS module 180 or the IMS applications 190. Advantageously, this allows IMS operators to leverage existing software and databases to provide web-based services without rewriting and updating legacy IMS applications 190a-n. In addition, the gateway 120 allows web service client developers to create native SOAP web service clients in a variety of programming languages without reliance on other forms of transport or protocols such as java-based web service clients or web browser-based web service clients.

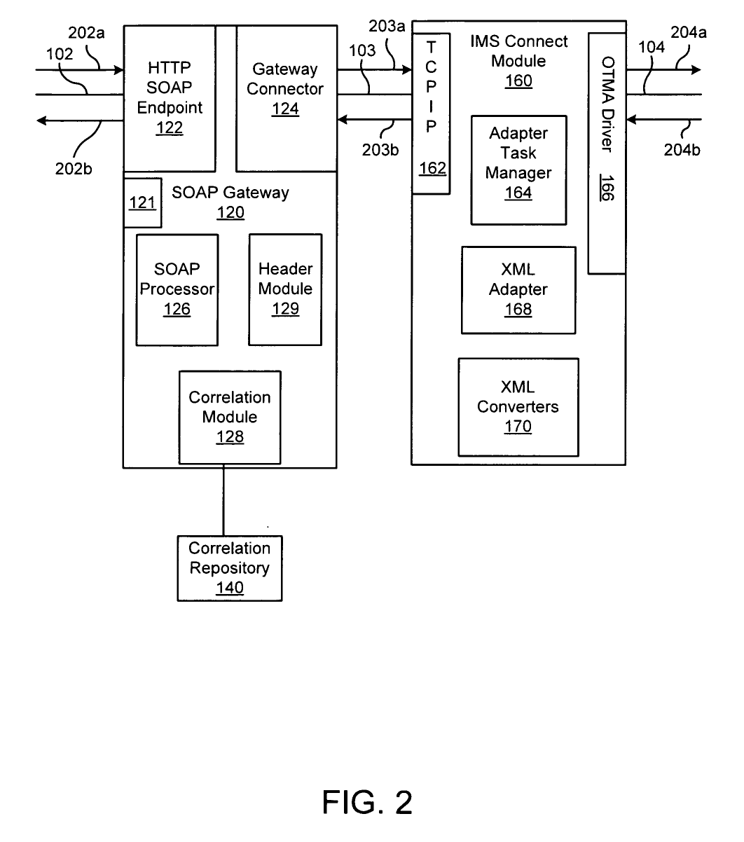

FIG. 2 illustrates a block diagram of a gateway 120 connected to an IMS Connect module 160 via a TCP/IP connection 103. The gateway 120 comprises an HTTP SOAP endpoint 122, a gateway connector 124, a SOAP processor 126, a correlation module 128, and a header module 129. In addition, the SOAP gateway 120 may further comprise one or more WSDL files 121 accessible by web service clients 110. The gateway 120 communicates with web service clients 110 (See FIG. 1) via a SOAP conversation 102.

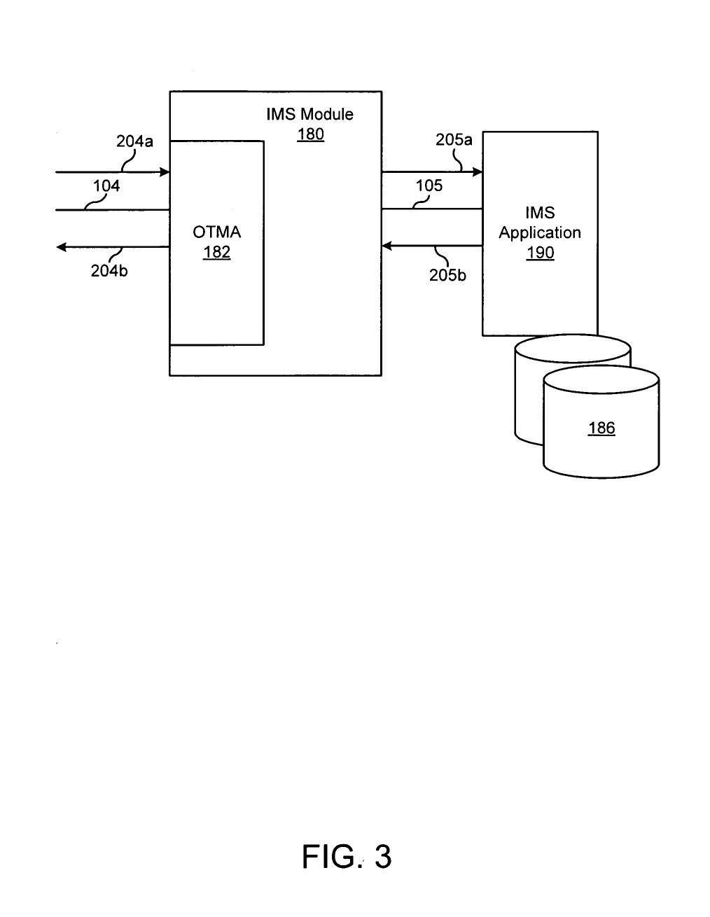

FIGS. 2 and 3 illustrate various connections and flows. Throughout the description of the various embodiments, a web service request/response encapsulated in a SOAP envelope is referred to as a SOAP web service request 202a. A web service request with no SOAP envelope is referred to as a web service request 203a. An OTMA call containing a web service request is referred to as a web service request call 204a. An OTMA response call containing a web service response is referred to as a web service response call 204b. A web service response without a SOAP envelope is referred to as a web service response 203b, and a web service response with a SOAP envelope is referred to as a SOAP web service response 202b.

The IMS Connect module 160 comprises a TCP/IP module 162, an OTMA driver 166, an adapter task manager 164, an XML adapter 168, and an XML converter 170. IMS connect module 160 communicates with the gateway 120 via a TCP/IP connection 103 and with IMS module 180 (See FIG. 1) via an OTMA call 104.

The HTTP SOAP endpoint 122 establishes a SOAP conversation 102 with a web service client 110. The SOAP conversation 102 typically utilizes HTTP as a transport mechanism. In one embodiment, the HTTP session utilizes a TCP/IP connection to TCP port 80. Many firewalls are configured to allow TCP/IP sessions to port 80. Using the HTTP transport to port 80 typically reduces the amount of firewall reconfigurations necessary to allow a SOAP session 102 from a web service client 110 to a gateway 120. Of course, the SOAP conversation may be configured to utilize a different TCP port. The HTTP SOAP endpoint 122 is the web aspect of the SOAP gateway 120.

The SOAP processor 126 decapsulates SOAP messages received from HTTP SOAP endpoint 122. Typically, the SOAP processor 126 parses a SOAP message and extracts an XML message from a SOAP web service request 202a. The SOAP processor 126 also encapsulates web service responses 203b to create SOAP web service responses 202b.

The gateway connector 124 establishes a TCP/IP connection 103 with the TCP/IP module 162 of the IMS Connect module 160. The gateway connector 124 sends web service requests 203a over the TCP/IP connection 103 to IMS Connect module 160 and receives web service responses 203b over the TCP/IP connection 103 from IMS Connect module 160

The TCP/IP connection 103 generally comprises a five-tuplet: a source IP address, a source port number, a destination IP address, a destination port number and a protocol. Generally, the gateway connector 124 uses its own source IP address and a source port number provided by the IP stack running on the gateway 120. The destination IP address and optionally the destination port number may be specified as correlation parameters in the selected correlation mapping. Typically, the protocol is TCP (transmission control protocol), but the UDP (unreliable delivery protocol) may be used as well. The protocol may also be specified as a correlation parameter. A single gateway connector 124 may connect to a plurality of IMS Connect modules 160 using a plurality of TCP/IP connections 103. The gateway connector 124 chooses among the plurality of IMS Connect modules 160a-n according to a correlation parameter contained in a correlation mapping selected from the correlation repository 140.

In one embodiment of system 100, the web service client 110 sends a SOAP web service request 202a to the HTTP SOAP endpoint 122 over the SOAP conversation 102. The SOAP endpoint 122 passes the SOAP web service request 202a to the SOAP processor 126. The SOAP processor 126 removes the SOAP envelope from the SOAP web service request 202a, leaving an XML web service request 203a. The SOAP processor 126 forwards the web service request 203a to the correlation module 128. The web service request 203a comprises input data which ultimately will be delivered to the IMS application 190 for processing. The web service request 203a further comprises an identifier which uniquely identifies the request web service.

The correlation module 128 extracts the identifier from the web service request 203a. The identifier may be a universal resource indicator (URI) or other name which uniquely identifies the requested web service. In one embodiment, the gateway 120 makes the identifier available to web service clients 110 via a WSDL file accessible by all web service clients 110. The WSDL file advertises the web services available on the gateway 120 and the parameters needed to properly call those advertised web services.

In one embodiment, the correlation module 128 uses the identifier as a key to access a correlation mapping contained in a correlation repository 140. The correlation repository 140 may contain correlation mappings for each web service available through the gateway 120. The header module 129 updates the web service request 203a by combining a header field comprising various parameters from the correlation mapping with the web service request 203a. The header module 129 then passes the web service request 203a to the gateway connector 124.

The gateway connector 124 may use parameters retrieved from the correlation mapping, to select a TCP/IP connection 103. The gateway connector 124 may be capable of establishing TCP/IP connections 103 to multiple IMS Connect modules 160a-n. The gateway connector 124 sends the updated web service request 203a to a particular IMS Connect module 160 selected according to the parameters in the correlation mapping.

The TCP/IP module 162 receives and establishes TCP/IP connections 103 with the gateway 120. Typically, one gateway 120 connects to a plurality of IMS Connect modules 160a-n. The adapter task manager 164 manages adapter tasks. An adapter task is adapted to call a specific language structure converter. The adapter task manager 164 selects the appropriate adapter based on the correlation parameters. In one embodiment, the adapter task manager 164 selects the appropriate adapter based on one of the correlation parameters which may be an adapter name extracted from the web service request 203a. In one example, the adapter task manager 164 calls an XML adapter 168 which in turn calls a common business oriented language (COBOL) XML converter 170 which converts the XML data to a COBOL application data structure format. In FIG. 2, the XML adapter 168 is a COBOL adapter 168. However, the XML adapter 168 and the XML converter 170 may be configured to convert XML data into byte data appropriate for language calls other than COBOL such as PL/1, assembler, and the like.

The IMS Connect module 160 typically receives a web service request 203a comprising an adapter name. As described above, the IMS Connect module 160 and/or the adapter task manager 164 uses the adapter name to select the appropriate adapter task 168 to process the web service request 203a. However, in some instances, no adapter task name is present in the web service request 203a. When no adapter name is present, no language conversion is necessary. In this case, the adapter task 164 passes the original XML message to the OTMA driver 166 to be passed on to the IMS module for processing by an IMS application 190. Again, the adapter task 164 may use an identifier extracted from the web service request 203a to determine the selection of the appropriate XML adapter 168 or the decision to call no adapter 168.

The adapter task manager 164 selects the appropriate adapter 168 based on parameters from the correlation mapping added by the header module 129. In the illustrated embodiment, the adapter task manager 164 selects the XML adapter 168 which in turn calls the XML converter 170. The converter 170 converts the XML data from the web service request 203a to application byte data compatible with an OTMA call to an IMS module 180. The OTMA driver 166 calls a particular IMS module 180 over an OTMA call 104. The OTMA driver 166 passes the application byte data to IMS module 180 through the OTMA call 104. Typically, the application byte data passed from the OTMA driver 166 to IMS module 180 is an OTMA web service request call 204a. After IMS processes the call, the IMS module 180 makes a web service response call 204b to the OTMA driver 166.

The IMS Connect module 160 passes the data from the web service response call 204b to the adapter task manager 164. The adapter task manager 164 selects the appropriate XML adapter 168 which in turn calls the appropriate XML converter 170. The data from the web service response call 204b is converted from a language specific format, for example COBOL, to an XML based web service response 203b. The TCP/IP module 162 passes web service response 203b over the TCP/IP connection 103 back to the gateway 120.

The gateway connector 124 receives and passes the web service response 203b to the SOAP processor 126. The SOAP processor 126 encapsulates the web service response 203b into a SOAP envelope. In some embodiments, the gateway 120 handles the return processing of the web service response synchronously with the original web service request. For the synchronous model, the original SOAP conversation 102 from the web service client 110 may be active. If the original web service SOAP conversation 102 is active, then the SOAP web service response 202b may be passed directly to the HTTP SOAP endpoint 122 which sends the SOAP web service response 202b to the web service client 110.

In another embodiment, the gateway 120 handles the response processing asynchronously. In the asynchronous embodiment, the correlation module 128 may extract a response identifier from the web service response 203b. The correlation module 128 extracts a correlation mapping from the correlation repository 140 based on the response identifier. The extracted correlation mapping may contain parameters necessary to locate the web service client 110 to which the gateway forwards the SOAP web service response 202b.

Those of skill in the art will understand that many different flows can be designed to handle a web service request and response. The flows illustrated here are just one embodiment of the SOAP gateway 120 functionality and other flows may be designed without departing from the spirit of the invention.

FIG. 3 illustrates an expanded view of one embodiment of the IMS module 180b and an IMS application 190. The IMS module 180b may comprise an OTMA module 182. The OTMA module 182 maintains an OTMA connection 104 with IMS Connect module 160. The OTMA connection 104 is generally not like the TCP/IP connection 103. While the TCP/IP connection 103 is a logical session which the gateway connector 124 and the TCP/IP module 162 maintain, the OTMA session 104 is generally a pair of queues connected to procedure control blocks (PCBs). The OTMA driver 166 queues a message to the PCB of the OTMA module 182. The queuing of a message to the PCB of the OTMA module 182 causes the operating system (e.g. z/OS) to run the OTMA module 182. Similarly, the OTMA module 182 queues messages to the PCB of the OTMA driver 166, causing the OTMA driver 166 to run and process the queued message.

FIG. 3 further illustrates one embodiment of an IMS application 190 in communication with the IMS module 180. The IMS application 190 communicates with the IMS application 190 through connection 105 which may be similar to the PCB queuing mechanism described in relation to the OTMA connection 104. As mentioned earlier, one IMS module 180b may connect to multiple IMS applications 190a-n. IMS applications 190 typically access at least one datastore 186. The datastore 186 comprises a hierarchical database. The database may contain bank account information for thousands of individual accounts. The IMS application 190 may be an application which queries the datastore 186 to determine the balance of a specific account. Another IMS application 190 may subtract money from one account in the datastore 186 while another application 190 may add money to an account in the datastore 186.

In one embodiment, IMS module 180 receives an OTMA web service request call 204a. The OTMA web service request call 204a is not an XML call. Rather, the OTMA web service request call 204a is formatted according to the byte data requirements of the OTMA module 182. The IMS application 180 extracts an IMS application identifier and a datastore identifier from the web service request call 204a. As an example, the IMS application identifier might be the transaction code “IVTNO,” and the datastore identifier might be “1208.” In this example, the IMS module 180 would execute the transaction “IVTNO,” and the IMS application “IVTNO” would execute its transaction using the datastore identified by “1208.”

The IMS module 180 queues the request call 205a to the PCB of the IMS application 190. IMS application 190 accesses the datastore 186 specified in the web service request call 205a and queues a web service response call 205b back to the IMS module 180. The web service response call 205b may indicate that the web service request call 205a completed successfully or that the web service request call 205a completed unsuccessfully. The web service response call 205b may contain response data such as the bank account balance information originally requested by the web service client 110.

IMS module 180 returns the response message 205b as an OTMA web service response call 204b to the same IMS Connect module 160. IMS Connect module 160 converts the web service response call 204b as described earlier and eventually returns a web service response 203b to the gateway 120 and eventually to the web service client 110 as a SOAP web service response 202b.

It is to be understood that the connections 102, 103, 104, and 105 between the various modules and software components are described here as connections or calls. However, each may be a connection between software modules running on the same computing device or separate computing devices. The types of connections are not limited to the described embodiments. Those of skill in the art will understand that the connections or calls may be remote procedure calls (RPC), TCP/IP calls, procedural software calls, SOAP messages, or other types of communication transmissions. The various connections 102, 103, 104, and 105 simply illustrate that data flow across the connections, normally in both directions at different times during processing. Typically, the web service response path follows the same path which the corresponding web service request call followed. For example, the same instance of the gateway 120 which processes the SOAP web service request 202a also processes the web service response 203b. Similarly, the same instance of the IMS Connect module 160 which processes the web service request 203a also processes the web service response call 204b.

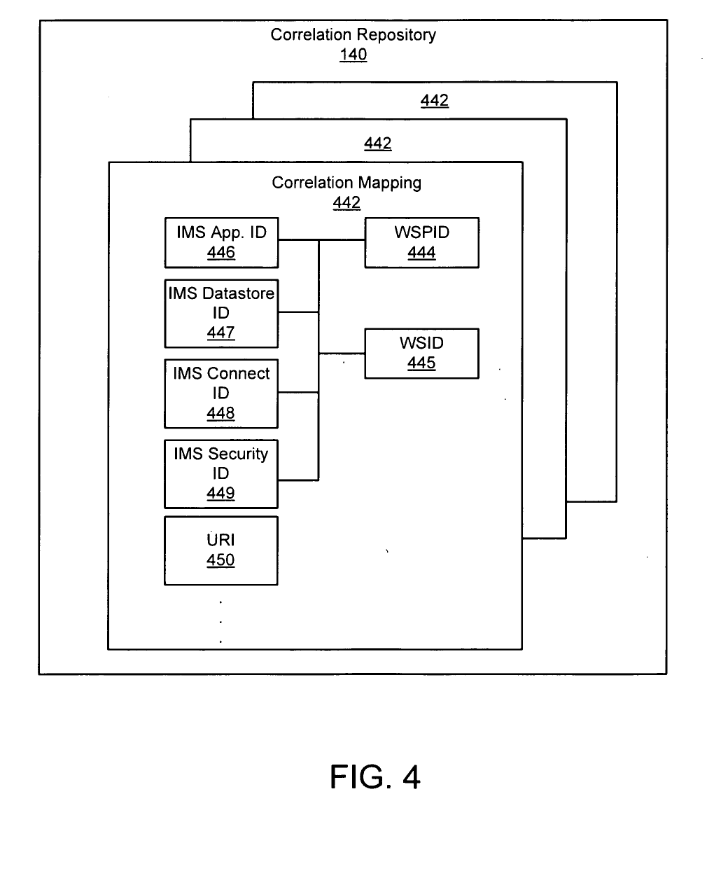

FIG. 4 illustrates one embodiment of a correlation repository 140. The correlation repository 140 comprises a plurality of correlation mappings 442. Each correlation mapping 442 comprises various parameters and identifiers. The depicted correlation mapping 442 comprises a mapping between a web service provider identifier (WSPID) 444 and at least four identifiers: an IMS application identifier 446, an IMS datastore identifier 447, an IMS Connect identifier 448, an IMS security identifier 449, and optionally a URI 450.

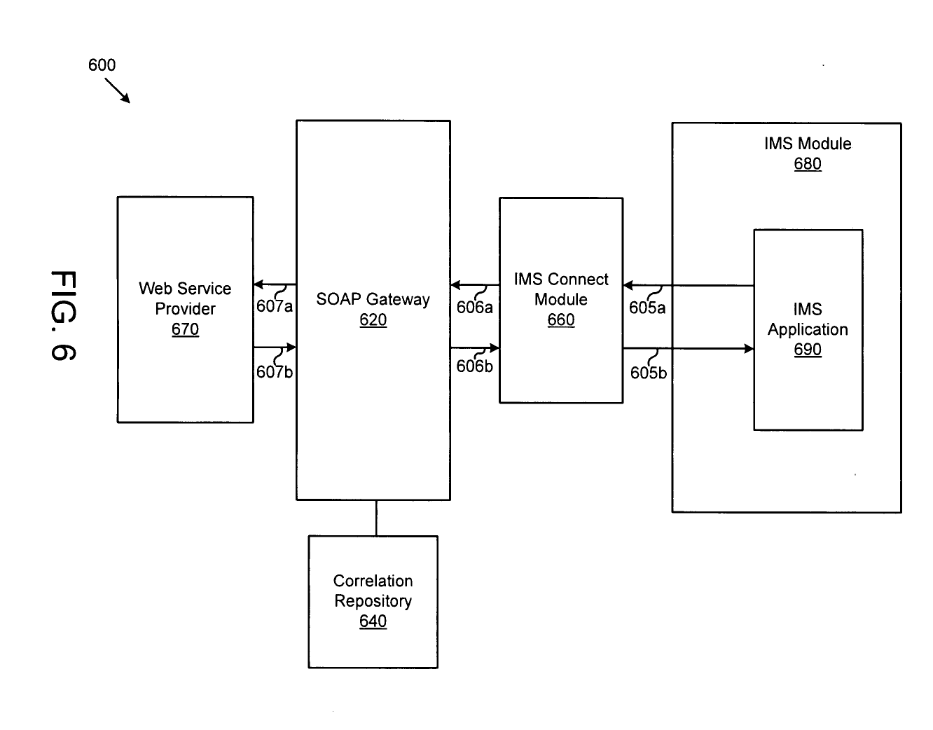

FIG. 4 also illustrates a web service identifier (WSID) 445 used to map a correlation mapping 442 to a group of identifiers which may include a URI 450, an IMS application identifier 446, an IMS datastore identifier 447, an IMS Connect identifier 448, and an IMS security identifier 449. Generally, the WSPID 444 is used by the SOAP gateway 120 for web service requests from a web client 110 and the WSID 445 is used for web service requests from an IMS application as described below in reference to FIGS. 6-9.

As described earlier, a web service client 110 creates a SOAP web service request 202a comprising various parameters including an identifier. The correlation module 128 extracts the identifier, for example, a WSPID 444, from the SOAP web service request 202a and selects a correlation mapping 442 from the correlation repository 140 based on the extracted WSPID 444. The header module 129 inserts the parameters from the correlation mapping 442 into the web service request 203a. Various components of the system 100 use the inserted parameters to route, authenticate, and process the web service request 203a.

The gateway connector 124 uses the IMS Connect identifier 448 to select the appropriate TCP/IP connection 103. The IMS Connect identifier 448 may comprise an IP address or a resolvable internet name and optionally a TCP port number. The gateway connector 124 may use the IP address and TCP port number to select an already existing TCP/IP connection 103 or to create a new TCP/IP connection 103 to a specific IMS Connect module 160a.

In one embodiment, the IMS connect identifier 448 further comprises an adapter identifier. The adapter task manager 164 may use the adapter identifier to select the appropriate XML adapter 168 and XML converter 170 to process the request and convert the request to the appropriate byte code format.

The IMS Connect module 160 may use the IMS security identifier 449 to authenticate the web service request. The security identifier 449 may comprise a username and password or other authentication parameters. The IMS Connect module 160 may refuse to reply to a web service request 203a containing an invalid IMS security identifier 449.

The IMS application identifier 446 typically identifies the IMS application 190 that the IMS module 180 will use to process the web service request call 204a. In one embodiment, the IMS application identifier 446 comprises a one to eight character transaction code, for example “IVTNO.” Similarly, the IMS datastore identifier 447 typically identifies the specific datastore 186 or database which the IMS application 190 will use in processing the web service request 205a.

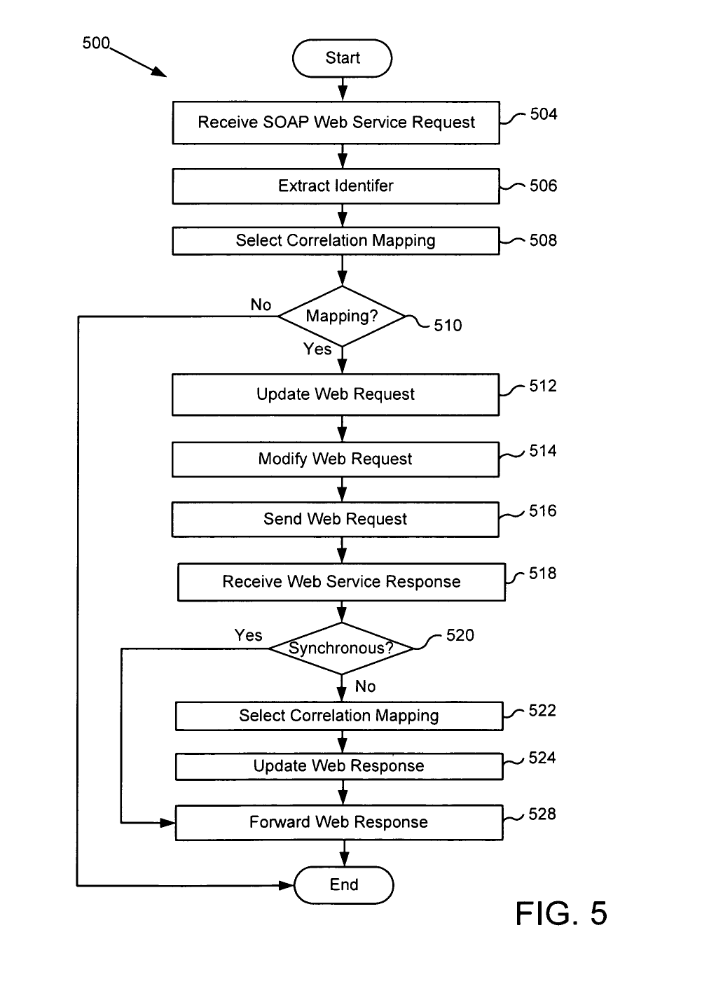

FIG. 5 illustrates one embodiment of a method 500 for implementing an IMS SOAP gateway 120. The method 500 may be implemented using the system 100 discussed above. Those of skill in the art recognize that hardware and software implementing portions of the present invention may be implemented in various modules within the system 100.

Initially, a web service client 110 sends a SOAP web service request 202a to the IMS SOAP gateway 120. The gateway 120 receives 504 the SOAP web service request 202a. The SOAP endpoint 122 passes the SOAP web service request 202a to the SOAP processor 126. The SOAP processor 126 extracts the web service request from the SOAP web service request 202a. The correlation module 128 extracts 506 an identifier or WSPID 444 from the web service request 203a. The WSPID 444 may be a URI or other unique identifier. The gateway 120 typically advertises the WSPID 444 to web service clients using a WSDL file 121.

The correlation module 128 further selects 508 a correlation mapping 442 based on the extracted WSPID 444. If the correlation module 128 does not find 510 a correlation mapping 442 with the extracted identifier 444, processing stops. Otherwise, the header module 129 updates 512 the web service request 203a with the parameters from the selected correlation mapping 442. In one embodiment, the header module 129 builds a header field and combines the new header field with the web service request 203a. The header module 129 preferably builds a header field containing an IMS application identifier 446, an IMS datastore identifier 447, an IMS connect identifier 448, an IMS security identifier 449 as well as other parameters contained in the selected correlation mapping 442.

Next, the gateway 120 forwards the updated web service request 203a to the IMS Connect module 160. Typically, the gateway sends 516 the web service request 203a to the IMS Connect module 160 over a TCP/IP connection.

After the gateway 120 sends 516, the modified web service request 203a to the IMS Connect module 160, the gateway 120 receives 518 a web service response 203b from the IMS Connect module 160. Next, the correlation module 128 determines 520 whether the web service response 202b is to be sent asynchronously or synchronously. For synchronous processing, the gateway 120 may forward 526 the web service response 202b to the web service client 110 over the SOAP connection 102.

For asynchronous processing, the gateway 120 may extract an identifier from the web service response 203b. The correlation module 128 may select 522 a correlation mapping 442 from the correlation repository 140 based on the extracted identifier. The selected correlation mapping 442 may have a URI or other parameter which identifies the web service client 110 to which the gateway 120 is to send the web service response 202b. The correlation module 128 updates 524 the web service response 202b. Next, the HTTP SOAP endpoint 122 forwards 526 the SOAP web service response 202b to the web service client 110 identified by the selected correlation mapping 442.

FIGS. 6, 7, 8, and 9 more particularly describe how the SOAP gateway 620 enables an IMS application 690 to operate as a web client. Many of the similarly named structures of FIGS. 1-5 play similar functional roles with respect to FIGS. 6-9. However, whereas the gateway 120 of FIG. 1 enables an IMS application 190 to operate as a web service provider, the SOAP gateway 620 enables an IMS application 690 to operate as a web service client.

FIG. 6 is a schematic block diagram illustrating one embodiment of a system 600 in accordance with the present invention. The system 600 comprises a web service provider 670, a SOAP gateway 620, an IMS Connect module software product 660, an IMS module software product 680, and an IMS application 690. The SOAP gateway 620 further comprises a correlation repository 640. The components of system 600 serve similar purposes to those described above with respect to the components of system 100 with the same names. In addition, the SOAP gateway 620 working in cooperation with the IMS Connect module 660, the IMS module 680, and the IMS application 690 serve a web service client role. In system 100, the web service client 110 requested web services of the gateway 120. In system 600, the SOAP gateway 620 operates as a web service client or web service consumer.

Web service provider 670 is a SOAP enabled web service provider. Web service clients request web services of a web service provider 670 by establishing a SOAP conversation with the web service provider 670. The web service provider 670 may be a computing device running an operating system such as Windows, AIX, Solaris, Linux, z/OS, or the like. In fact, the web service provider may be a system 100 comprising an additional gateway 120 and an IMS module 180 acting as a web service provider.

System 600 generally illustrates the case where the SOAP gateway 620 and the IMS components 660, 680, and 690 cooperate to function as a web service client. IMS application 690 may be an application or a program executing as part of IMS module 680. IMS application 690 may be a financial transaction program which is configured to retrieve the cash balance of a stock trading account. The stock trading account may be accessible through a web service provider 670. The IMS application 690 is generally capable of communicating with the IMS module 680 but is not capable of issuing SOAP requests to the web service provider 670. The SOAP gateway 620, the IMS connect module 660, and the IMS module 680 provide the functionality necessary for the IMS application to call out to the web service provider 670 and receive a web service response in a format that the IMS application 690 may understand.

The IMS module 680 is a transactional manager and hierarchical database system. The IMS module 680 provides the environment in which the IMS application 690 executes. The IMS module 680 and the IMS Connect module 660 serve functions similar to those described earlier with respect to the IMS module 180 and the IMS Connect module 160. The IMS module 680 and the IMS Connect module 660 translate byte code calls from the IMS application 690 into XML messages understandable to the SOAP gateway 620.

The SOAP gateway 620 is further configured to receive XML-based web service requests from the IMS Connect module 660 and pass those to the web service provider 670 as SOAP messages. The SOAP gateway 620 presents a modern, SOAP interface to the web service provider 670 and an XML interface to the IMS Connect module 660. The SOAP gateway 620 further comprises a correlation repository 640 similar to the correlation repository 140.

In one embodiment, to initiate a web service request, IMS application 690 builds a web service request 605a containing a WSID 445 (See FIG. 4). The IMS application 690 queues the web service request 605a for delivery to the IMS Connect module 660. The WSID 445 identifies the web service provider with which the IMS application 690 desires to communicate. The WSID may be a URI, a name, an eight byte character field, or other identifier. The web service request 605a may be an XML encoded message or a byte encoded structure usable by a compiled language, for example COBOL.

The IMS Connect module 660 translates the message 605a as necessary into an XML web service request 606a, using the same adapter and conversion module described above. The IMS Connect module 660 passes the XML web service request 606a to the SOAP gateway 620.

The SOAP gateway 620 parses the XML web service request 606a and extracts the WSID 445 from the message. The SOAP gateway 620 extracts a correlation mapping 442 (See FIG. 4) from the correlation repository 640 based on the extracted WSID. The extracted correlation mapping 442 may comprise a URI, an IMS application identifier 446, an IMS datastore identifier 447, an IMS Connect identifier 448, and an IMS security identifier 449. It may also comprise other parameters which the SOAP gateway 620 may use either in processing the web service request 606a or in routing the web service request 606a and in routing a web service response 607b, 606b. The SOAP gateway 620 passes the web service request as a SOAP message 607a to the web service provider 670, selected according to the extracted correlation mapping 442.

The web service provider 670 processes the web service request 607a and returns a SOAP encapsulated web service response 607b. The SOAP gateway 620 may handle the response 607b synchronously or asynchronously. When the SOAP gateway 620 processes the web service response 607b synchronously, the SOAP gateway 620 may use the previously extracted correlation mapping including the IMS application identifier and adapter name to modify the web service response 607b. The SOAP gateway 620 inserts the IMS application identifier into the web service response 606b for use by the IMS Connect module 660 in routing the web service response 606b to the desired IMS application.

The SOAP gateway 620 forwards the modified web service response 606b to the IMS Connect module 660 which translates the response 606b as needed from an XML message to a byte language message 605b. The IMS Connect module 660 passes the response 605b to the IMS module 680 which passes the response 605b to the original IMS application 690 as indicated by the IMS application identifier found in the web service response 605b.

In one embodiment of system 600, IMS application 690 initiates a synchronous web service request. For example, IMS application 690 may issue a synchronous TCP/IP socket call to send out a callout request 605a. The IMS application 690 embeds the WSID into the callout request 605a as described above. In one embodiment, the IMS application 690 sends the callout request 605a out as application bytes. The IMS application 690 then sleeps or waits until the response 605b arrives at the same IMS application 690. The IMS Connect module 660 receives the callout request 605a. An adapter task manager 164 (See FIG. 2) may call an XML adapter 168 to translate the byte message 605a into an XML encoded web service request 606a. The XML adapter 168 may select a language specific converter module, for example an XML COBOL converter 170, to assist in the translation of the byte message to an XML encoded web service request 606a.

The IMS Connect module 660 sends the web service request 606a to the SOAP gateway 620. The SOAP gateway 620 retrieves the callout request 606a from the IMS Connect module 660. The processing continues as described above. The gateway extracts correlation parameters from the correlation repository 640 according to the WSID contained in the web service request 606a. The gateway encapsulates the request 606a into a SOAP encapsulated web service request 607a and forwards the web service request 607a to the web service provider. The web service response 607b is received by the SOAP gateway 620 and forwarded through the IMS Connect module 660 and the IMS Module 680 to the IMS application 690. The IMS application 690 receives the response 605b on the same socket session on which the original web service request 605a was sent out.

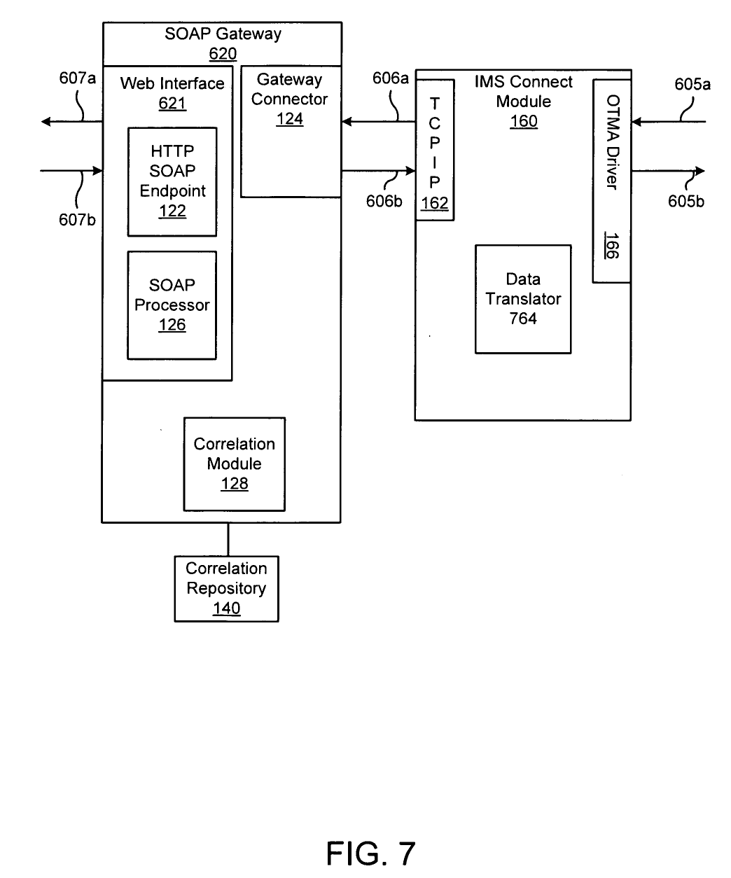

FIG. 7 illustrates an expanded view of the SOAP gateway 620 and the IMS Connect module 160. The SOAP gateway 620 comprises a web interface 621, a gateway connector 124, a correlation module 128, and a correlation repository 140. The IMS Connect module 160 comprises a TCP/IP module 162, an OTMA driver 166, and a data translator module 764.

The OTMA driver 166 and the TCP/IP module 162 serve similar purposes to those described with respect to FIG. 2. The data translator module comprises the functionality similar to that of the adapter task manager 164, the XML adapter 168, and the XML converters 170. The data translator 764 converts the web service request 605a to an XML format if the web service request 605a is not already in an XML format. The data translator 764 shields the OTMA driver 166 and the IMS application from needing to format web requests 605a into XML format.

The TCP/IP module 162 maintains a TCP/IP connection with the gateway connector 124 and forwards XML encoded web service requests 606a to the gateway connector 124. The gateway connector 124 receives XML encoded web service requests 606a. The correlation module 128 extracts the WSID 445 from the web service request 606a and selects a correlation mapping 442 from the correlation repository 140 based on the WSID 445.

The web interface 621 presents a web services client appearance to the network. Web service providers 670 view the SOAP gateway 620 as a web service client. The web interface 620 presents this image to the web service providers 670. In reality, the SOAP gateway 620 enables IMS applications 690 to access web service providers 670 while appearing to the web service provider 670 to be a native web service client.

The web interface 621 comprises a SOAP processor 126 and an HTTP SOAP endpoint 122. The SOAP processor 126 and the HTTP end point 122 provide substantially the same functionality as the structures with similar names described in reference to FIG. 2. The SOAP processor 126 encapsulates the XML web service request 606a in a SOAP envelope. The HTTP SOAP endpoint 122 transmits the SOAP message 607a to a web service provider 670 designated by a URI 450 from the correlation mapping 442 extracted from the correlation repository 140. The web interface 621 transmits the web service request 607a on a SOAP session and receives a web service response 607b on the same session.

The SOAP gateway 620 may retain the correlation mapping 442 in memory for use in processing the web service response 607b. Typically, the SOAP processor 126 extracts a web service response 606b from the SOAP encapsulated web service response 607b. The extracted web service response 606b is an XML encoded message containing the response from the web service provider 670. The web interface 621 may insert an IMS application identifier 446 as well as an adapter name into the web service response 606b. The gateway connector 124 transmits the XML encoded web service response 606b to the IMS connect module 160. The data translator 764 translates the XML encoded web service response 606b into a byte encoding in accordance with the value of the IMS adapter name stored in the web service response 606b. The IMS application identifier 446 or IMS transaction code is used by the IMS Connect module 160 to select the IMS application to which the web service response 606b is transmitted. An IMS application identifier 446 identifies one IMS application 790.

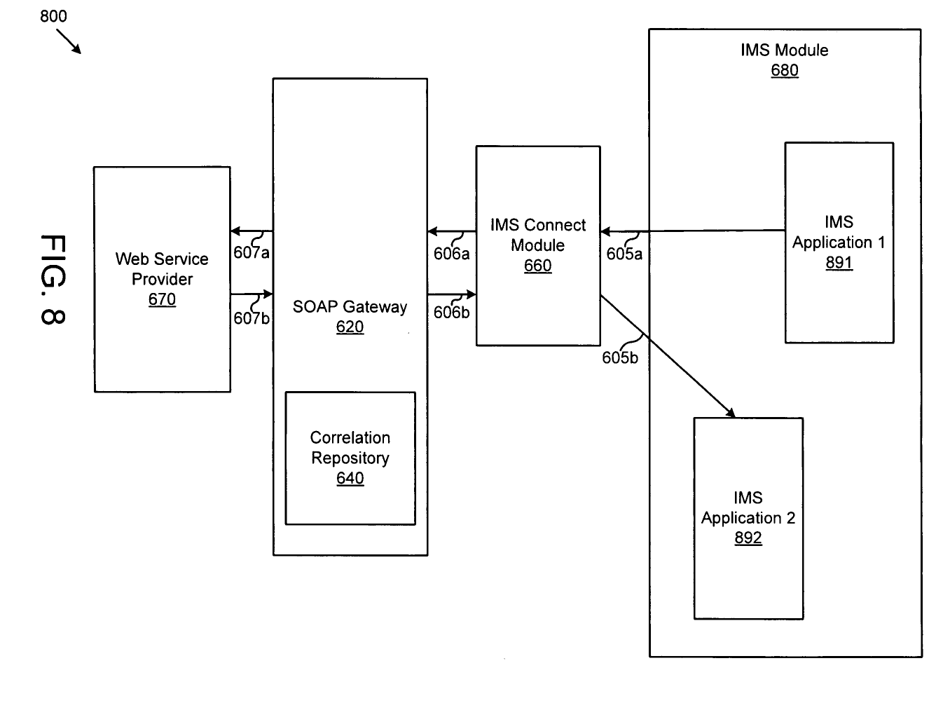

FIG. 8 illustrates an alternative embodiment of a system 800 of the present invention. The system 800 is similar to system 600, except that system 800 illustrates an asynchronous processing scheme with respect to the IMS module 680 and the IMS application1 891 and IMS application2 892. IMS application1 891 initiates the web service request 605a as in system 600. However, IMS application1 891 does not wait for a response 605b. IMS application2 892 processes the web service response 605b. The IMS application2 892 may be invoked in response to the arrival of the response 605b, or, alternatively, may be a long-running process which processes the web service responses 605b as they arrive.

The IMS application identifier 446 extracted by the correlation module 128 from the correlation mapping and inserted into the web service response 606b identifies the second IMS application2 892 rather than the IMS application 891. The IMS module 680 is configured to forward the response to IMS application2 892 based on the IMS application identifier 446 embedded in the web service response 605b. In this manner, IMS application1 891 need not block and wait for the web service response 605b. IMS application1 891 is able to continue processing other requests, and the system 800 may run more efficiently. The IMS module 680 may optionally select the destination IMS application at the time the web service response 605b is received.

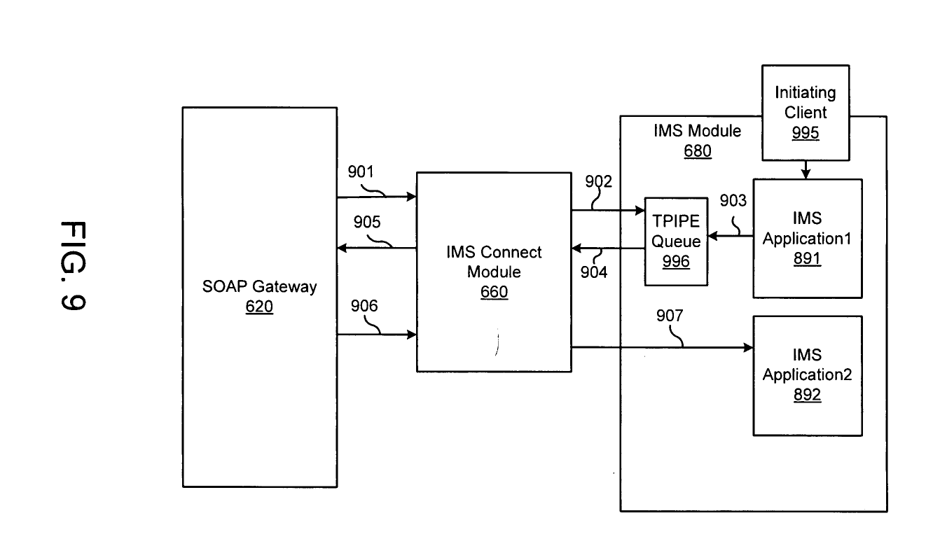

FIG. 9 illustrates an expanded view of the SOAP gateway 620, the IMS Connect module 660, and the IMS module 680 of system 800. In this illustration, the IMS module 680 comprises the, a transaction PIPE queue 996, and the IMS applications 891 and 892. IMS module 680 may further comprise an initiating client component 995.

In one embodiment of the system 800, upon initialization of SOAP gateway 620, SOAP gateway 620 sends a resume transaction pipe (TPIPE) command 901 to the IMS Connect module 660. The IMS Connect module 660 creates, initializes, or connects to 902 a TPIPE queue 996 in response to the resume TPIPE command 901. Initiating client 995 may invoke or execute the IMS application1 891. The IMS application1 891 creates a web service request 903. In one embodiment of an IMS application1 891, the web service request 903 is a byte encoded message created in COBOL. In another embodiment, the IMS application1 891 creates an XML encoded web service request 903.

The IMS application1 891 sends a callout 903 comprising the web service request 903. To issue the callout, the IMS application1 891 issues an insert to the alternate procedure control block (ISRT ALTPCB). The insert to the ALTPCB is similar to queuing a message to the work queue of another process. In invoking the insert ALTPCB, the IMS application1 891 specifies the TPIPE queue 996 as the queue upon which the web service request 903 is queued. The IMS application1 891 may simultaneously create a synchronization point which may be used in processing a web service response 907 when the web service response 907 arrives. The initializing client 995 may be an operator sitting at a terminal or an independent program running on the same or a separate computing device from the IMS module 990. The initiating client 995 may for example be requesting the account balance of an account accessible through web service provider 670 (See FIG. 8).

The TPIPE queue 996 may be thought of as a queue that receives web service requests 903 and saves them until the IMS Connect module 660 is able to process the web service requests 903. If flow 903 precedes flow 902, the TPIPE queue 996 holds the web service request 903 until the IMS Connect module 660 is ready to process the web service request 903. IMS Connect module 660 in turn processes the web service request message 904, translates the web service request 904 as necessary as described above, and forwards an XML web service request 905 to SOAP gateway 620. The SOAP gateway 620 executes the processing described above to send a web service request 607a to the web service provider 670 and receive the web service response 607b from a SOAP enabled web service provider 670 (See FIG. 8).)

As described in reference to FIG. 7, the SOAP gateway 620 selects an IMS application identifier 446 from a correlation mapping 442 according to a WSID 445 extracted from the web service request 905. The web correlation module 128 of the SOAP gateway 620 inserts the application identifier 446 into the web service response 905 and creates web service response 906 from the web service response 905.

The IMS connect module 660 translates the web service response 906 to a web service response 907 and forwards the web service response 907 to a selected IMS application 891, 892 identified by the application identifier 446 in the web service response 907. The value of the application identifier 446 stored in the correlation mapping 442 determines whether the web service response is transmitted to the original application 891 in a synchronous fashion or to IMS application2 892 in an asynchronous fashion with respect to the original IMS application1 891.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A simple object access protocol (soap) gateway for facilitating interaction: between an International Business Machines (IBM) Information Management Systems (IMS) software product and a web service, the gateway comprising:
a gateway connector configured to establish an IP connection to an IMS software product comprising an IMS Connect software product and an IMS application, the IMS application configured to initiate a web service request and communicate the web service request to the gateway connector via the IMS Connect software product, the web service request comprising an identifier;
a correlation module configured to extract the identifier from the web service request and select a correlation mapping based on the extracted identifier wherein the correlation mapping maps the identifier to a SOAP enabled web service provider; and
a web interface module configured to encapsulate the web service request in a SOAP message and transmit the web service request to the web service provider.

2. The gateway of claim 1 wherein the identifier is a web service identifier (WSID), and the correlation mapping comprises a mapping between the WSID and one or more correlation parameters.

3. The gateway of claim 2 wherein the IMS Connect software product comprises:
a TCPIP module configured to receive the IP connection from the gateway connector;
a data translator configured to convert between an XML message and an Open Transaction Manager Access (OTMA) call; and
an OTMA driver configured to communicate with IMS applications.

4. The gateway of claim 2 wherein the gateway connector is further configured to send a resume transaction pipe (TPIPE) to the IMS software product over the IP connection.

5. The gateway of claim 4 wherein the IMS software product enables a TPIPE queue in response to the resume TPIPE, the TPIPE configured for receiving web service requests from the IMS application.

6. The gateway of claim 2, wherein the correlation parameters comprise a universal resource indicator (URI) that identifies a web service provider and an IMS transaction code that identifies an IMS application, the correlation module further configured to insert the URI into the web service request and to insert the IMS transaction code into a web service response received from the service provider.

7. The gateway of claim 6, wherein the processing of the web service response is handled synchronously, the web interface receiving the web service response in the same SOAP session in which the web interface sent the web service request.

8. The gateway of claim 7, wherein the processing of the web service response by the IMS software product is handled asynchronously by a second IMS application.

9. The gateway of claim 1, the gateway further comprising a correlation tool configured to add an additional correlation mapping based on a new WSID.

10. The gateway of claim 1, the gateway further comprising a correlation repository configured to store a set of correlation mappings.

11. The gateway of claim 10 wherein the correlation repository is a file accessible by the correlation module.

12. A signal bearing medium tangibly embodying a program of machine-readable instructions executable by a digital processing apparatus to perform operations to facilitate interaction between an Information Management System (IMS) software product and a web service provider, the operations comprising:
sending a resume transaction pipe to an IMS software product;
enabling a transaction pipe queue to receive web service requests from an IMS application in response to the insert to the ALTPCB;
receiving a web service request from an IMS application comprising an identifier;
enqueuing a web service request from an IMS application to the TPIPE;
receiving the enqueued web service request from the IMS software product;
extracting an identifier from the web service request;
selecting a correlation mapping from a correlation repository based on the identifier;
modifying the web service request to include a universal resource indicator (URI) based on the correlation mapping;
encapsulating the web service request in a SOAP envelope and sending the encapsulated web service request to the web service destination.

13. The signal bearing medium of claim 12, the operations further comprising receiving a web service response encapsulated in a SOAP envelope and sending the web service response to a second IMS software application for asynchronous processing.

14. The signal bearing medium of claim 12 wherein the identifier is a web service identifier (WSID).

15. The signal bearing medium of claim 14 wherein the correlation mapping maps a single WSID to the universal resource indicator (URI) of the web service provider.

16. The signal bearing medium of claim 15 wherein selecting comprises querying a correlation repository containing correlation parameters indexed according to web service identifiers (WSIDs) from which the correlation mapping is selected.

17. The signal bearing medium of claim 12 further comprising:
sending the web service response to the IMS software product; and
asynchronously processing the web service response in a second IMS application.

18. A computer program product comprising a computer usable medium having computer usable program code for providing a SOAP gateway between an Information Management System (IMS) software product and a web service, said computer program product including;
computer usable program code for deploying a computer program product on a computer system and
computer usable program code for executing the computer program product having modules comprising:
an gateway connector configured to establish an IP connection to an IMS software product comprising an IMS Connect software product and an IMS application, the IMS application configured to initiate a web service request and communicate the web service request to the gateway connector via the IMS Connect software product, the web service request comprising a web service identifier (WSID);
a correlation module configured to extract the WSID from the web service request and select a correlation mapping based on the extracted WSID wherein the correlation mapping maps the WSID to one or more correlation parameters, wherein one of the correlation parameters identifies a web service provider; and
a web interface module configured to encapsulate the web service request in a SOAP message and transmit the web service request to the web service provider.

19. The computer program product of claim 18, wherein the correlation parameters comprise a universal resource indicator (URI) and an IMS transaction code, the correlation module further configured to insert the URI into the web service request and to insert the IMS transaction code into a web service response received from the service provider.

20. The computer program product of claim 19, wherein the gateway connector is configured to transmit the web service response to a second IMS application selected based on a transaction code extracted from the correlation parameters.
